(19) United States
(12) Patent Application Publication
(10) Pub. No.: US 2025/0077220 A1
(43) Pub. Date: Mar. 6, 2025

(54) SENSOR, ASSOCIATED METHOD AND NETWORK

(71) Applicant: Aktiebolaget SKF, Göteborg (SE)

(72) Inventors: Johann WITTENBERG, Gerolzhofen (DE); Clément POULAILLEAU, Amboise (FR); Nicolas LIGNEE, la Membrolle sur Choisille (FR)

(21) Appl. No.: 18/818,707

(22) Filed: Aug. 29, 2024

(30) Foreign Application Priority Data
Sep. 5, 2023 (DE) 102023208525.9

(51) Int. Cl. G06F 8/65; G06F 21/56

(52) U.S. Cl. CPC G06F 8/65; G06F 21/565

(57) ABSTRACT

A sensor (2) includes a first memory (6) for storing a current version (SOFT-0) of an application software. A second memory (7) stores a predetermined sensor identifier (ID0). A third memory (8) stores a first version (SOFT-1) of the application software. A fourth memory (9) stores a flag (FL). A boot memory (5) stores an initial software (SOFT-I). A processing means (11) implements the current version (SOFT-0) of the application and the initial software (SOFT-I).

### CROSS-REFERENCE TO RELATED APPLICATION

This application claims priority to German Application No. 102023208525.9, filed Sep. 5, 2023, the entirety of which is hereby incorporated by reference.

### FIELD

The present disclosure is directed to a sensor.

More particularly, the present disclosure deals with updating an application software stored in a memory of a sensor.

### BACKGROUND

Generally, a network may comprise a plurality of sensors communicating wirelessly with a gateway to transmit measurements.

Each sensor comprises an application software implemented by a processing unit of the sensor for example to take measurements, process the measurements and send the processed measurements to the gateway.

The application software may be updated.

During an updated, the sensor is booted so that an initial software stored in a boot memory updates the application software stored in the sensor.

During the update, the sensor does not communicate with the gateway.

In a mesh network, each sensor is synchronized with the gateway. During the update of the application software, the more the duration of the update is important, the more the sensor is desynchronized with the mesh network and does not send data to the gateway, for example measurements, decreasing the availability of the sensor.

Resynchronizing the updated sensor totally desynchronized is time costly, for example up to 10 minutes.

Further, when the sensor comprises a battery supplying the said sensor, during resynchronization, the power consumption of the sensor is increased reducing the life duration of the battery.

Besides, the boot memory is designed to store the initial software intended to process the update of the sensor reducing for example the memory storing the application software when the memory size in the sensor is limited.

The initial software intended to process the update of the sensor is more complex than an initial software and may comprise more errors than an initial software which does not comprise update instructions.

Consequently, the present disclosure intends to reduce the duration to resynchronize the sensor with the network after an update of an application software of the said sensor to increase the availability of the sensor and to limit the power consumption of the said sensor.

### SUMMARY

According to an aspect a method for updating an application software stored in a first memory of a sensor is proposed.

The method comprises:
implementing the current version of the application software stored in the first memory to compare a predetermined sensor identifier stored in a second memory of the sensor with a first identifier of a first version of the application software stored in a third memory,
implementing the current version of the application software to set a flag stored in a fourth memory in a first state when the first identifier includes the predetermined sensor identifier,
implementing the current version of the application software to boot the sensor to launch an initial software stored in a boot memory when the flag stored in the fourth memory is in the first state,
implementing the initial software to read the flag stored in the fourth memory, and

when the state of the flag is equal to the first state:
implementing the initial software to replace the current version of the application software stored in the first memory by the first version of the application software stored in the third memory and to set the flag in a second state different from the first state so that the first memory stores the first version of the application software.

The current version of the application software checks the compatibility of the first version of the application software with the sensor and boots the sensor to update the said application software if the first version of the application software is compatible with the sensor reducing the duration of the update implemented by the initial software to reduce the duration of none communication between the said sensor and the gateway.

The reduction of the none communication duration reduces the duration to synchronize the said sensor with the gateway after the update and reduces the power consumption of the sensor for example to increase the life duration of the battery of the sensor.

Further, as the compatibility check instructions are included in the current version of the application software, the initial software has a smaller size as an initial software known from the prior art permitting to reduce the size of the boot memory and is simpler than an initial software known from the prior art reducing the probability of error in the initial software.

Preferably, the current version of the application software comprises a second identifier and the first version of the application software comprises a second identifier, implementing the current version of the application software further comprises setting the flag in the second state when the second identifier of the current version of the application software is equal to the second identifier of the first version of the application software.

Advantageously, the first version of the application software comprises a first set of data and a second set of data to check the integrity of the first set of data, the method further comprises implementing the initial software to check the integrity of the first set of data of the first version of the application software stored in the first memory from the second set of data of the first version of the application software stored in the first memory, and implementing the first set of data of the first version of the application software stored in the first memory when the first set of data of the first version of the application software stored in the first memory has integrity.

Preferably, when the first set of data of the first version of the application software stored in the first memory has not integrity, the method further comprises implementing the initial software to erase the first memory, to set the flag in the first state, and to boot the sensor to launch the initial software.

According to another aspect, a sensor is proposed.

The sensor comprises:
a first memory configured to store a current version of an application software,
a second memory configured to store a predetermined sensor identifier,
a third memory configured to store a first version of the application software,
a fourth memory configured to store a flag,
a boot memory configured to store an initial software, and
processing means configured to implement:
the current version of the application software to compare the predetermined sensor identifier with a first identifier of the first version of the application software,
the current version of the application software to set the flag in a first state when the first identifier includes the predetermined sensor identifier and to boot the sensor to launch an initial software stored in the boot memory when the flag stored in the third memory is in the first state,
the initial software to read the flag stored in the third memory, and when the state of the flag is equal to the first state, to replace the current version of the application software stored in the first memory by the first version of the application software stored in the third memory and sets the flag in a second state different from the first state.

Advantageously, the processing means are further configured to implement the current version of the application software to set the flag in the second state when a second identifier of the current version of the application software is equal to a second identifier of the first version of the application software.

Preferably, the first version of the application software comprises a first set of data and a second set of data to check the integrity of the first set of data, the processing means are further configured to implement the initial software to check the integrity of the first set of data of the first version of the application software stored in the first memory from the second set of data of the first version of the application software stored in the first memory, and to implement the first set of data of the first version of the application software stored in the first memory when the first set of data of the first version of the application software stored in the first memory has integrity.

Advantageously, when the first set of data of the first version of the application software stored in the first memory has not integrity, the processing means are further configured to implement the initial software to erase the first memory and to boot the sensor to launch the initial software.

Preferably, the sensor further comprises electric storage means configured to supply the sensor.

According to another aspect, a network is proposed.

The network comprises:
a gateway,
at least one sensor as defined above, the sensor further comprising communication means configured to communicate wirelessly with the gateway.

### BRIEF DESCRIPTION OF THE DRAWINGS

Other advantages and features of the present disclosure will appear on examination of the detailed description of embodiments, in no way restrictive, and the appended drawings in which:

FIG. 1 illustrates schematically an example of a network according to the present disclosure; and

FIG. 2 illustrate an example of a method to update a sensor of the network according to the present disclosure.

### DETAILED DESCRIPTION

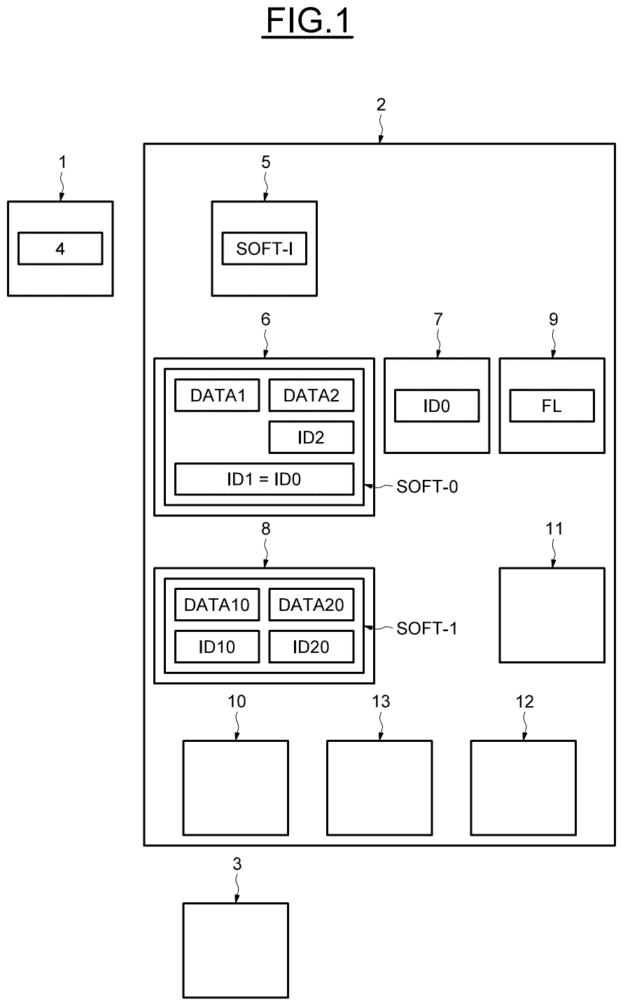

Reference is made to FIG. 1 which represents an example of a network comprising a gateway 1, a first sensor 2, and a second sensor 3.

The network 1 may be a mesh network.

In variant, the network 1 comprises more than two sensors.

The gateway 2 comprises communication means 4.

As the first sensor 2 and the second sensor 3 have the same architecture, only the first sensor 2 is detailed.

The first sensor 2 comprises a boot memory 5 storing an initial software SOFT-I to boot the said sensor, a first memory 6 storing a current version SOFT-1 of an application software, a second memory 7 storing a predetermined sensor identifier ID0, a third memory 8 storing a first version SOFT-1 of the application software, and a fourth memory 9 storing a flag FL.

The flag FL may be in a first state or a second state.

For example, the flag FL in the first state is equal to a Boolean value “1” and the flag FL in the second state is equal to a Boolean value “0”.

The boot memory 5 and the second memory 7 are a non-volatile memory, and the first memory 6 and the third memory 8 may be volatile or non-volatile memories.

In variant, the first, second, third and fourth memories 6, 7, 8, 9 may be one memory.

The sensor 2 further comprises communication means 10, processing means 11, and may comprise electric storage means 12.

The electric storage means 12 include for example a battery.

In variant, the sensor 2 may be supplied with a grid.

The communication means 10 of the first and second sensors 2, 3 communicate with the communication means 4 of the gateway 1.

The first sensor 2 further comprises measuring means 13.

The measurement means 13 comprise for example a measurement interface measuring the temperature outside the first sensor 2 and/or measuring the vibration of a machine on which the first sensor 4 is fixed.

The processing means 11 comprise for example a processing unit implementing the boot, first, second, third, and fourth memories 5, 6, 7, 8, 9, the communication means 10, and the measurement means 13.

The processing means 11 implement the initial software SOFT-I and the current version SOFT-0 of the application software.

The first and second sensors 2, 3 and the gateway 1 may communicate wirelessly, for example using a Mesh protocol or a Bluetooth protocol.

The predetermined sensor identifier ID0 is assigned to the first sensor 2 during its manufacturing and represents the version of the hardware of the first sensor 2.

Each version SOFT-0, SOFT-1 of the application software comprises a first set of data DATA1, DATA10 and a first identifier ID1, ID10.

The first identifier ID1, ID10 represents the version(s) of the hardware of the said sensor 2, 3 compatible with the said version SOFT-0, SOFT-1 of the application software.

The first identifier ID1 of the current version SOFT0 of the application software is equal to the predetermined sensor identifier ID0.

The first set of data DATA1, DATA10 comprises instructions to implement the communication means 10 and the measuring means 13, and instructions to update the current version of the application software.

Each version SOFT-0, SOFT-1 of the application software may comprise a second identifier ID2, ID20 representative of the version of the application software.

The second identifier ID2 is representative of the version SOFT-0 of the application software stored in the first memory 6, and the second identifier ID20 is representative of the first version SOFT-1 of the application software stored in the third memory 8.

Each version SOFT-0, SOFT-1 of the application software may further comprise a second set of data DATA2, DATA20 to check the integrity of the first set of data DATA1, DATA10.

The second set of data DATA2, DATA20 is for example intended to perform a cyclic redundancy check CRC of the first set of data DATA1, DATA10.

The first version SOFT-1 of the application software may be download by the communication means 10 of the first sensor 2 from the gateway 1.

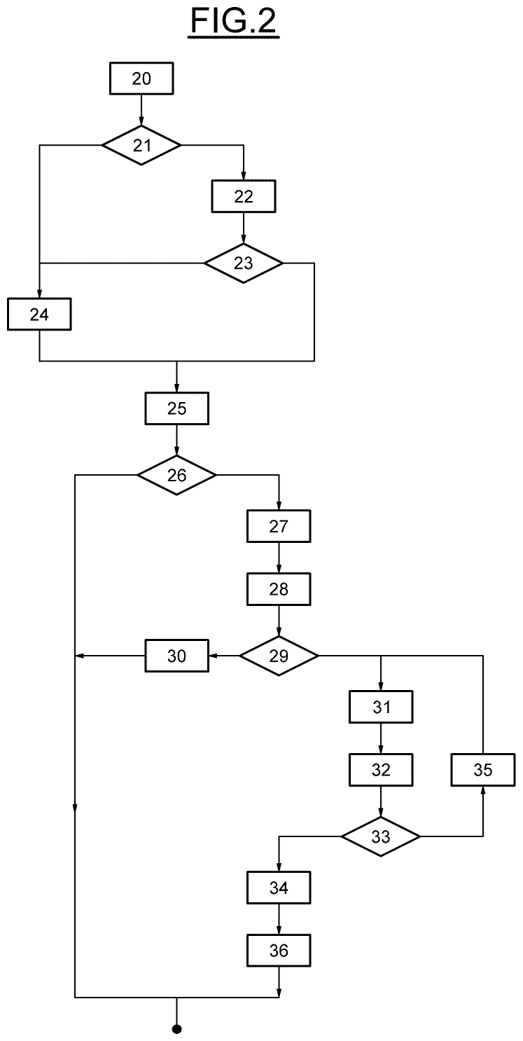

FIG. 2 illustrates an example of a method to update the current version of the application software stored in the first memory 6 of the first sensor 2.

It is assumed that the first and second sensors 2, 3 are synchronized with the gateway 1 so that the network is synchronized, and that the processing means 11 implement the current version SOFT-0 of the application software.

It is further assumed that the flag FL is in the second state.

During a first step 20, when the processing means 11 have detected that the first version SOFT-1 of the application software is stored in the third memory 8, the processing means 11 implement the current version SOFT-0 of the application software stored in the first memory 6 to compare the predetermined sensor identifier ID0 with a first identifier ID10 of the first version SOFT-1 of the application software stored in the third memory 8.

If the first identifier ID10 of the first version SOFT-1 of the application software is equal to the predetermined sensor identifier ID0 (step 21), during a step 22, the current version SOFT-0 of the application software implemented by the processing means 13 sets the flag FL in the first state and compares the second identifier ID2 of the current version SOFT-0 of the application software with the second identifier ID20 of the first version SOFT-1 of the application software.

If the second identifier ID2 of the current version SOFT-0 of the application software is equal to the second identifier ID20 of the first version SOFT-1 of the application software (step 23), the method continues at a step 24.

If the second identifier ID2 of the current version SOFT-0 of the application software is not equal to the second identifier ID20 of the first version SOFT-1 of the application software (step 23), the method continues at a step 25.

If the first identifier ID10 of the first version SOFT-1 of the application software is not equal to the predetermined sensor identifier ID0 (step 21), the method continues at step 24.

If at least one version of the application software of the current and the first version of the application software does not comprise a second identifier, the method skips step 23.

During the step 24, the current version SOFT-0 of the application software implemented by the processing means 13 sets the flag FL in the second state.

During the step 25, the current version SOFT-0 of the application software implemented by the processing means 13 reads the state of the flag FL stored in the fourth memory 9.

If the flag FL is in the second state (step 26), the update is aborted and the processing means 13 continues to implement the current version SOFT-0 of the application software so that the first sensor 2 continues to run with the current version SOFT-0 of the application software.

If the flag FL is in the first state (step 26), during a step 27, the current version SOFT-0 of the application software implemented by the processing means 13 boots the first sensor 2 to launch the initial software SOFT-I.

When the initial software SOFT-I is implemented by the processing means 13, in a step 28, the initial software SOFT-I implemented by the processing means 13 reads the flag FL stored in the fourth memory 9.

When the flag FL is in the second state (step 29), during a step 30, the processing means 13 implement the current version SOFT-0 of the application software and the current version SOFT-0 of the application software implemented by the processing means 13 resynchronized the first sensor 2 with the gateway 1. The update of the current version of the application software is aborted.

When the flag FL is in the first state (step 29), during a step 31, the initial software SOFT-I implemented by the processing means 13 replace the current version SOFT-0 of the application software stored in the first memory 6 by the first version SOFT-1 of the application software stored in the third memory 8 and to set the flag FL in the second state.

The first memory 6 stores the first version SOFT-1 of the application software.

During a step 32, the initial software SOFT-I implemented by the processing means 13 checks the integrity of the first set of data DATA10 of the first version SOFT-1 of the application software stored in the first memory 6 from the second set of data DATA20 of the first version SOFT-1 of the application software stored in the first memory 6.

If the first set of data DATA10 of the first version SOFT-1 of the application software stored in the first memory 6 has integrity (step 33), in a step 34, the processing means 13 implement the first version SOFT-1 of the application software stored in the first memory 6, the first version SOFT-1 of the application software stored in the first memory 6 being the current version of the application software.

During a step 36, the current version of the application software implemented by the processing means 13 resynchronized the first sensor 2 with the gateway 1.

If the first set of data DATA10 of the first version SOFT-1 of the application software stored in the first memory 6 has no integrity (step 33), in a step 35, the initial software SOFT-I implemented by the processing means 13 crases the first memory 6 to erase the first version SOFT-1 of the application software stored in the said memory 6, sets the flag in the first state, and boots the first sensor 2 to launch the initial software SOFT-I.

The method continues at step 31 when the initial software SOFT-I is implemented by the processing means 13.

When the first version SOFT-1 of the application software does not comprise the second data set DATA20, the steps 32, 33, 34, 35 are skipped so that the method goes from step 31 to step 36, the first version SOFT-1 of the application software stored in the first memory 6 being the current version of the application software.

The current version of the application software of the sensor checks the compatibility of the first version of the application software with the sensor and boots the sensor to update the said application software if the first version of the application software is compatible with the sensor reducing the duration of the update implemented by the initial software to reduce the duration of none communication between the said sensor and the gateway.

The reduction of the none communication duration reduces the duration to synchronize the said sensor with the gateway after the update and reduces the power consumption of the sensor for example to increase the life duration of the battery of the sensor.

Further, as the compatibility check instructions are included in the current version of the application software, the initial software has a smaller size as an initial software known from the prior art permitting to reduce the size of the boot memory and is simpler than an initial software known from the prior art reducing the probability of error in the initial software.

What is claimed is:

1. Method for updating an application software stored in a first memory of a sensor, the method comprising:
implementing the current version of the application software stored in the first memory to compare a predetermined sensor identifier stored in a second memory of the sensor with a first identifier of a first version of the application software stored in a third memory,
implementing the current version of the application software to set a flag stored in a fourth memory in a first state when the first identifier includes the predetermined sensor identifier,
implementing the current version of the application software to boot the sensor to launch an initial software stored in a boot memory when the flag stored in the fourth memory is in the first state,
implementing the initial software to read the flag stored in the fourth memory, and
when the state of the flag is equal to the first state:
implementing the initial software to replace the current version of the application software stored in the first memory by the first version of the application software stored in the third memory and to set the flag in a second state different from the first state so that the first memory stores the first version of the application software.

2. The method according to claim 1, wherein the current version of the application software comprises a second identifier and the first version of the application software comprises a second identifier, implementing the current version of the application software further comprises setting the flag in the second state when the second identifier of the current version of the application software is equal to the second identifier of the first version of the application software.

3. The method according to claim 1, wherein the first version of the application software comprises a first set of data and a second set of data to check the integrity of the first set of data, the method further comprises implementing the initial software to check the integrity of the first set of data of the first version of the application software stored in the first memory from the second set of data of the first version of the application software stored in the first memory, and implementing the first set of data of the first version of the application software stored in the first memory when the first set of data of the first version of the application software stored in the first memory has integrity.

4. The method according to claim 3, wherein when the first set of data of the first version of the application software stored in the first memory has not integrity, the method further comprises implementing the initial software to erase the first memory, to set the flag in the first state, and to boot the sensor to launch the initial software.

5. The method according to claim 2, wherein the first version of the application software comprises a first set of data and a second set of data to check the integrity of the first set of data, the method further comprises implementing the initial software to check the integrity of the first set of data of the first version of the application software stored in the first memory from the second set of data of the first version of the application software stored in the first memory, and implementing the first set of data of the first version of the application software stored in the first memory when the first set of data of the first version of the application software stored in the first memory has integrity.

6. The method according to claim 5, wherein when the first set of data of the first version of the application software stored in the first memory has not integrity, the method further comprises implementing the initial software to erase the first memory, to set the flag in the first state, and to boot the sensor to launch the initial software.

7. A sensor comprising:
a first memory configured to store a current version of an application software,
a second memory configured to store a predetermined sensor identifier,
a third memory configured to store a first version of the application software,
a fourth memory configured to store a flag,
a boot memory configured to store an initial software, and
processing means configured to implement:
the current version of the application software to compare the predetermined sensor identifier with a first identifier of the first version of the application software,
the current version of the application software to set the flag in a first state when the first identifier includes the predetermined sensor identifier and to boot the sensor to launch an initial software stored in the boot memory when the flag stored in the third memory is in the first state,
the initial software to read the flag stored in the third memory, and when the state of the flag is equal to the first state, to replace the current version of the application software stored in the first memory by the first version of the application software stored in the third memory and sets the flag in a second state different from the first state.

8. The sensor according to claim 7, wherein the processing means is further configured to implement the current version of the application software to set the flag in the second state when a second identifier of the current version of the application software is equal to a second identifier of the first version of the application software.

9. The sensor according to claim 7, wherein the first version of the application software comprises a first set of data and a second set of data to check the integrity of the first set of data, the processing means is further configured to implement the initial software to check the integrity of the first set of data of the first version of the application software stored in the first memory from the second set of data of the first version of the application software stored in the first memory, and to implement the first set of data of the first version of the application software stored in the first memory when the first set of data of the first version of the application software stored in the first memory has integrity.

10. The sensor according to claim 9, wherein when the first set of data of the first version of the application software stored in the first memory has not integrity, the processing means are further configured to implement the initial software to erase the first memory and to boot the sensor to launch the initial software.

11. The sensor according to claim 7, further comprising electric storage means configured to supply the sensor.

12. The sensor according to claim 8, wherein the first version of the application software comprises a first set of data and a second set of data to check the integrity of the first set of data, the processing means is further configured to implement the initial software to check the integrity of the first set of data of the first version of the application software stored in the first memory from the second set of data of the first version of the application software stored in the first memory, and to implement the first set of data of the first version of the application software stored in the first memory when the first set of data of the first version of the application software stored in the first memory has integrity.

13. The sensor according to claim 12, wherein when the first set of data of the first version of the application software stored in the first memory has not integrity, the processing means are further configured to implement the initial software to erase the first memory and to boot the sensor to launch the initial software.

14. The sensor according to claim 13, further comprising electric storage means configured to supply the sensor.

15. A network comprising:
a gateway,
at least one sensor according to claim 7, the sensor further comprising communication means configured to communicate wirelessly with the gateway.

16. A network comprising:
a gateway,
at least one sensor according to claim 14, the sensor further comprising communication means configured to communicate wirelessly with the gateway.
